(19) United States
(12) Patent Application Publication
(10) Pub. No.: US 2002/0188677 A1
(43) Pub. Date: Dec. 12, 2002

(54) Method and apparatus for termination of a session without causing user dissatisfaction

(75) Inventors: James T. Brady, San Jose, CA (US); Welden N. Thees, San Jose, CA (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: FORECOURT COMMUNICATION GROUP

(21) Appl. No.: 10/165,933

(22) Filed: Jun. 10, 2002

Related U.S. Application Data
(60) Provisional application No. 60/297,296, filed on Jun. 11, 2001.

(51) Int. Cl. G06F 15/16

(52) U.S. Cl. 709/203

(57) ABSTRACT

Apparatus, and a corresponding method, configured into a system, and using the prior history of a venue, similar venue, user or similar user, to present activities to said user operating in a time constrained manner, such that activities that must complete are unlikely to be present to the user and that activities that can be terminated with minimal impact on the user are likely to be presented when the time constraint is reached. The system is composed of: user terminals in various venues; an activity database with must-complete and terminate-able activities who's probable duration can be estimated; a mechanism to estimate the time available to present activities to the user; an activity selection means that chooses the activity type based on the likelihood that the activity will complete within the remaining time available for activities; and activity termination mechanisms for each type of activity.

### CROSS REFERENCE TO RELATED APPLICATION

The present application is claiming priority of U.S. Provisional Application Serial No. 60/297,296 filed on Jun. 11, 2001.

### FIELD OF THE INVENTION

This invention relates to a system for presenting activities to users of terminals with variable available time, in a manner that will minimize the user dissatisfaction when the system unilaterally terminates an activity.

### BACKGROUND OF THE INVENTION

This invention relates generally to point-of-service computer systems of the type used in venues, such as multilane retail stores, gas stations, and banks to record transactions, where these systems have the additional ability to involve the customer in activities during the portion of the primary transaction that does not require the customers attention. If the customer is involved in a activity when the primary transaction ends, the proprietor does not want the customer to continue with that activity because it will reduce the throughput of the point-of-service location (gas pump, checkout counter, ATM, . . . ). Specifically the invention provides a method and apparatus for structuring and presenting activities having characteristics that allow them to be abruptly terminated without the user being dissatisfied.

### SUMMARY OF THE INVENTION

The method of the invention involves the creation of activities that can be presented to users of a second user's interface attached to a point-of-service terminal, that can be gracefully terminated by a point-of-service terminal when the primary transaction of the point-of-service terminal has completed (terminate-able activities). Said terminate-able activities being selected from a larger pool of activities which contain activities that must complete (must-complete activities), even if the primary transaction of the point-of-service terminal has completed. The objective of the invention being the minimization of the number of activities that extend beyond the primary transaction. An additional objective is the maximization of user satisfaction by presenting a richer set of activities

A number of means are provided to: construct activities of the must-complete and terminate-able types, determine when must-complete activities can be presented or when terminate-able activities must be presented, select an activity of the determined type, present the activity, and complete the session in a manner consistent with the activity type.

The invention performs the steps of collecting information from customer transactions at specific store locations; aggregating that information; and analyzing the aggregated information for: extracting the probability of habitual activities; determining a likely speed of the customers response to various presentations; constructing dialogs of the activities to be presented to the user; detecting the customers presence at the point-of-service terminal; determining whether to use must-complete or terminate-able activity; presenting the activity to the customer; selecting subsequent activities for presentation or terminating the current activity in a manner based on its type.

### BRIEF DESCRIPTION OF THE DRAWINGS

FIG. 1 is an Overview of the invention

FIG. 2 is a block diagram of a computer System, which is adapted to perform the method of the invention.

FIG. 3 is a diagram of Estimating Time Fits.

FIG. 4 is a block diagram of a computer system called the Point-of-Service Terminal.

FIG. 5 is a block diagram of a computer system called the Venue Server.

FIG. 6 is a diagram that describes a User Session.

FIG. 7 is a diagram of a tree structure that represents a User Activity Dialog.

FIG. 8 is a data table that describes a User Venue Profile.

FIG. 9 is a data table that describes the User Identification Card Table.

FIG. 10 is a data table that describes a Venue Definition Table.

FIG. 11 is a data table that describes the Idle Time Message.

FIG. 12 is a Point-of-Service Terminal Table.

FIG. 13 is a data table that describes a Venue Profile Table.

FIG. 14 is a data table that describes a User Session Table.

FIG. 15 is the Activity Table

FIG. 16 is a generated table of the Proposed Activities List.

FIG. 17 is an Venue Activity Work Table.

FIG. 18 is the Session Results Table.

FIG. 19 is a Screen Definition Table.

FIG. 20 is an activity diagram that describes User Action Cycle.

FIG. 21 is a flow chart describing Idle Time Utilization.

FIG. 22 is a flow chart describing Value Packing.

FIG. 23 is a flow chart for Activity Selection.

FIG. 24 is a flow chart describing Activity Presentation.

### DETAILED DESCRIPTION OF THE INVENTION

The invention is described in terms of a multilane venue (that is, a venue with multiple checkout counters), but applies to other retail, wholesale, and financial institutions.

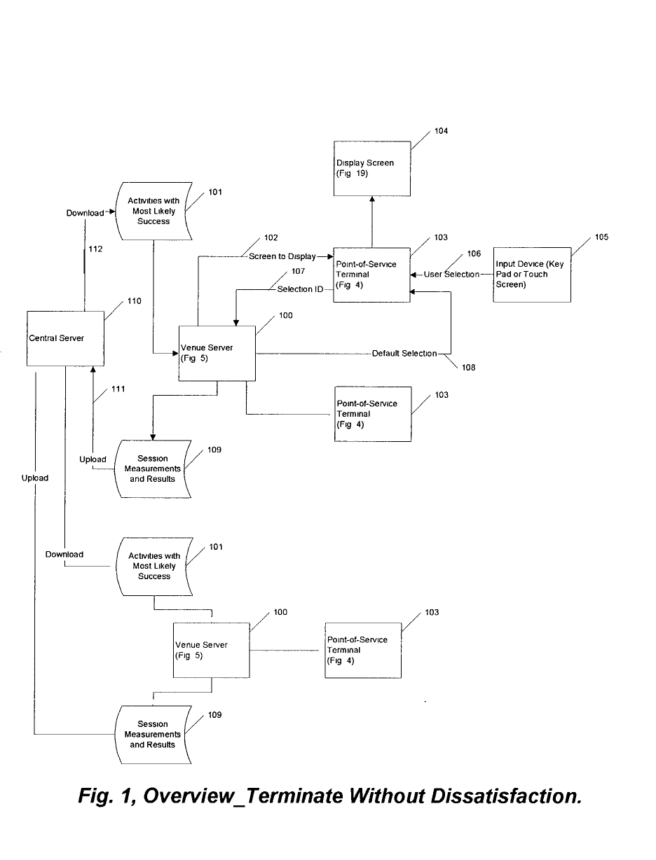

FIG. 1 is an Overview of the invention. It shows a view of how the user interacts with the system during Idle Time. The system is presenting offers to the user that they are most likely to respond favorably to and that can be completed in the Idle Time. Historical data on user selections are gathered for each Venue and sent back to the Central Server to be used to calculate probabilities of the most likely activities the user (or user type in the case of anonymous users) would respond favorably to. Data is also collected on response times and is used with the current system response time, the estimated idle time and estimated completion time of activities to calculate probabilities of completion time.

This invention concerns using historical data to determine the most best Activities to present and terminating a user session without user dissatisfaction when idle time runs out. The advantage of this design, is that Activities that Must-Complete, can be presented to the user when in the appropriate place and when there is enough time for them to complete. Conversely, Activities can be designed that can be terminated for the user, by the system, when possible overruns in time would be a problem or when there isn't much time available.

There are three things that make an activity Terminate-able; One; The flag set for each activity by the designer (Activity Completion Flag 1502 is “Must-Complete or “Terminate-able”). Two; the flag set for each Terminal when it is set up (Terminal Activity Completion Flag 1202 is “Must-Complete Allowed” or “Terminate-able Only”). Three; the Default Selection ID 1901, set by the designer, for each screen that participates in a Terminate-able activity.

Activities, with a Activity Completion Flag 1502 of “Must-Complete”, are only allowed on terminals where Terminal Activity Completion Flag 1202 is “Must-Complete Allowed” (an express lane in a grocery store would probably have a Terminal Activity Completion Flag 1202 of “Terminate-able Only”.)

The diagram shows a Central Server 110 connected to the Venue Servers 100. Each Venue has it's own Venue Server 100 which is connected to one to many Point-of-Service Terminals 103. The Venue Server 100 processes Activities with Most Likely Success 101 and performs an activity cycle of screen presentation and user response via the Point-of-Service Terminal 103 to the user. The Screen to Display 102 is sent to the Point-of-Service Terminal 103. The Point-of-Service Terminal 103, will Display Screen 104 which has one to many offers, only one of which can be selected by the user. The user will respond via an Input Device 105. The Input Device 105 is associated to one of the offers on the Display Screen 104. The User Selection 106 is received by the Point-of-Service Terminal 103 and then the Selection ID 107 is sent back to the Venue Server 100 for processing.

This invention allows for the Venue Server 100 to send a Default Selection 108 for the user, in place of the user activating an Input Device 105. A Default Selection 108 is only sent if the Idle Time has expired and the Activity Completion Flag 1502 for the current activity is set to “Terminate-able”.

The activity designer must decide what Activities should be “Terminate-able” and then, for each of the Screens that may come up in the activity, what would be the best Default Selection for the offers on the screen. Examples of good candidates for “Must-Complete” activities would be a purchase, reservation, or voting Offers to print out coupons would be good choices for a “Terminate-able” activity.

The Activities with Most Likely Success 101 are processed on the Central Server 110 using data collected and then an Upload 111 from the Venue Server 100, Session Results Table 519. Session Results Table 519, contains Session Measurements and Results 109 the users are making to the offers. The Central Server 110 processes the data to come up with lists of the Activities with Most Likely Success 101 for the day of the week and time of the day. The Central Server 110 can also use Session Measurements and Results 109 from other similar Venues to come up with the Activities with Most Likely Success 101. The Central Server 110 can also use the Session Measurements and Results 109 from other Venues to estimate Activity Time of similar activities. This is especially useful when a deciding on the best Activities to present at a new venue or when a new activity is designed and the initial Activity Time Distribution Parameters 1505 need to be filled.

The updated Activities with Most Likely Success 101 are sent from the Central Server 1 10, via Download 112, into the Venue Servers 202. The Activities with Most Likely Success 101, are stored in the User Venue Profile Table (for identified users) or Venue Profile Table (for anonymous users) for ready access.

The Activities with Most Likely Success 101 are processed again, when the user session begins, by the Venue Server 100, to find the Activities that fit the Point-of-Service Terminal 103 (Terminal Activity Completion Flag 1202 and Activity Completion Flag 1502 are compatible) and whose Time-Value 1604 will fit into the estimated Idle Time.

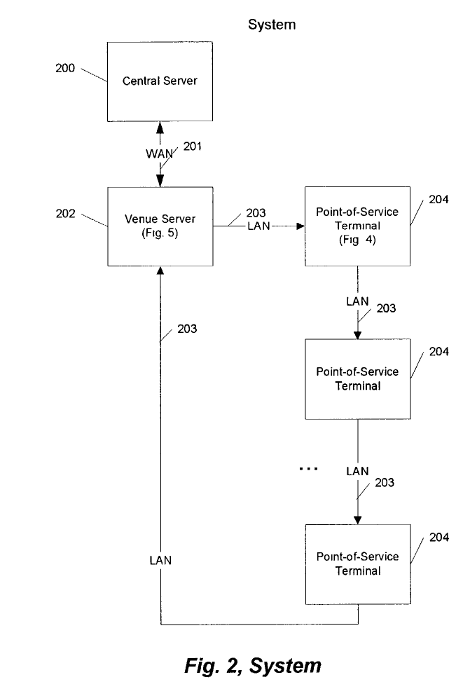

FIG. 2 is a block diagram of a network of computers adapted to perform the method of the invention. A Central Server 200 is coupled by a WAN 201 (Wide Area Network) to one or more Venue Servers 202. Readily available software and protocols such a TCP/IP are used by Central Server 200 and Venue Server 202 to communicate with each other via WAN 201. Venue Server 202 is connected via LAN 203 (Local Area Network) to one or more Point-of-Service Terminals 204. Normal Point-of-Service Terminal activities are conducted between the Venue Server 202 and Point-of-Service Terminal 204. These activities are well documented elsewhere and the details are not important to this invention. Venue Server 202 selects activities to be presented via Point-of-Service Terminal 204 and receives responses from Point-of-Service Terminal 204 as the user interacts with the activities. Central Server 200 acts as a consolidation point for gathering the information from multiple Venue Servers 202.

The arrangement of the system and the distribution of function, as described in this embodiment, is one of many possible alternatives.

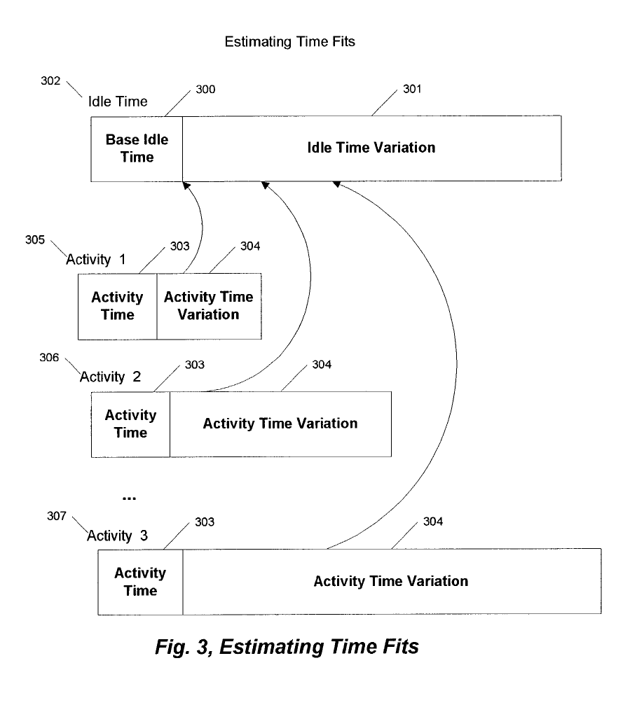

FIG. 3 describes the characteristics of how estimated Activity Time 303 fits into estimated Idle Time 302. Activities are selected who's estimated Activity Time 303 will complete in the estimated Idle Time 302. Idle Time 302 is composed of Base Idle Time 300 and Idle Time Variation 301, which can be represented by a probability distribution giving the probability that Idle Time 302 will complete in a specified time. Idle Time 302 is Base Idle Time 300 which can range, depending on changing variables which are represented by Idle Time Variation 301. One of first criteria used to select Activities, is the probability that the Activity Time 303 can complete in the Idle Time 302. The diagram shows three Activities (Activity 1 305, Activity 2 306, and Activity 3 307) but this list can be any length. In like manner, Activities have similar variations and representations. The variations described as items Idle Time Variation 301 and Activity Time Variation 304 are shown as having a finite limit, but in practice the tails on these variations can be quite long. The method described is concerned with establishing the probability that an Activity (Activity 1 305 or Activity 2 306,

Activity 3 307) will complete in Idle Time 302. In the case of Activity 1 305, the probability is high that it will complete. However, if Activity 1 305 used the maximum amount of time (higher Activity Time Variation 304) and the Idle Time 302 had a small Idle Time Variation 301, it would complete after the Idle Time 302 had completed. In the cases of Activity 2 306 and Activity 3 307, the probability of completion is successively lower.

Suppose that the activities selected for presentation to the user are Activity 1 305, Activity 3 307, and Activity 2 306 in that order. If Activity 1 305 completes prior to the end of the Idle Time 302, then the idle time probability distribution used for Idle Time 302 has to be renormalized to account for the portion used by Activity 1 305. After renormalization Activity 3 307 can be tested to see if the probability it will complete is sufficient. If so, it is presented and the process continues. Otherwise, Activity 2 306 would be tested in the same manner. In the course of this process none, all, or any combination of the activities could be presented to the user prior to the end of Idle Time 302.

The order the Activities is important (shown as Activity 1 305, Activity 2 306, and Activity 3 307), it is determined by the optimization used. In the case of the embodiment described, it is the time-value of the activities, although many other optimizations are possible. Thus in this example Activity 1 305 has the highest time-value, Activity 3 307 the next highest time-value, and Activity 2 306 the lowest. It should be noted that the time-value of an Activity is dependent on the current state of the system presenting user Activity 700, and the user to whom it is presented, as these will have varying effects on the time it takes to present Activity 700.

An important aspect of this invention is the ability of the system to terminate a user session for the user in such a way that the user will not be dissatisfied. There are four basic parts to accomplish this; First is the Activity Completion Flag 1502 where a flag, for each Activity, is set by the designer that indicates the activity is “Terminate-able” or “Must-Complete”. Second is the Terminal Activity Completion Flag 1202, where each Terminal is marked as one that allows “Terminate-able Only” activities or “Must-Complete Allowed”. Third, is the Default Selection ID 1901, set by the designers for each Screen. This is the input response to the Screen that the system will execute for the user. Fourth, is the calculation of the probability of the User to be able to complete the activity in the estimated Idle time available. The judgment of the designer, when setting the flags for Terminate-able activities, requires that they choose activities and default responses that will not cost the user anything or upset them by aborting a session they have invested their time in.

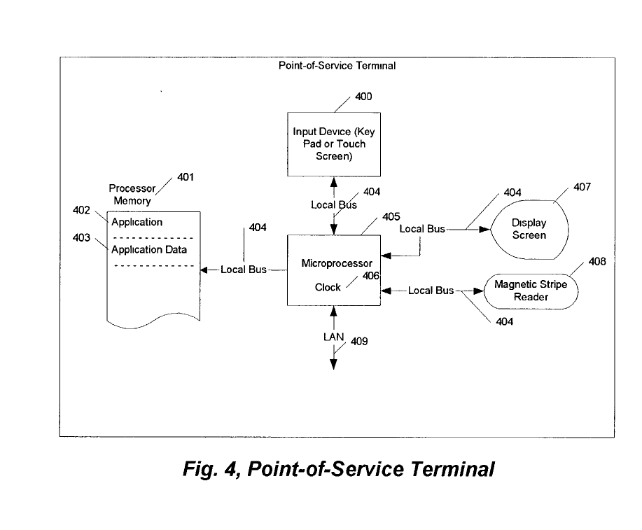

FIG. 4 illustrates further details of Point-of-Service Terminal (as seen in FIG. 3 Point-of-Service Terminal 204). Point-of-Service Terminal performs the functions of presenting information to the user and receiving the response to that presentation. The configuration shown is representative of Point-of-Service Terminal 204, but does not include all possible input and output devices. Microprocessor 405 is a conventional microprocessor with a Local Bus 404 that connects it to Processor Memory 401. Microprocessor 405 contains a Clock 406 that provides time in a form that includes the Month, Day-of-week, Hour, Minute, etc. Clock 406 is needed to take Timestamps of Actions to calculate both system and user response times. Processor Memory 401 contains Application 402 that performs the following functions: presentation of Activities 700, collection of responses from the user during the presentation of an Activity 700. This information is stored as Application Data 403 into Processor Memory 401 and is transferred to and from Venue Server 202 via LAN 409 as needed. Application 402 are selected software applications for processing the data. Input Device 400 is normally a keypad or touch screen, but could be any other form of input device such as an audio response unit. Input Device 400 is used to collect responses from the user. It is attached to Microprocessor 405 via a commonly a standard interface like the RS-232 standard. Display Screen 407 is a visual output device such as a Cathode Ray Tube (CRT), a flat panel liquid crystal display (LCD), or similar device. Other types of output devices, such as audio output units, can be used for this function. Display Screen 407 presents Activities 700 to the user or other users of the system. It is attached to Microprocessor 405 by Local Bus 404. Magnetic Stripe Reader 408 is an input device attached to Microprocessor 405 via Local Bus 404. It is used to collect user information from credit, debit, loyalty, and other ID cards having a magnetic stripe.

The function of Point-of-Service Terminal 204 could be performed by PC, client and server machines having additional capabilities. This includes being package with the Venue Server 202 or Central Server 200. Point-of-Service Terminal 204 responds to the control messages from the Venue Server 202, and does not require long-term storage of Application Data 403, but can take advantage of nonvolatile storage when it is present.

FIG. 5, Venue Server 202 is a representation of a typical Venue Server 202 and can be configured with the appropriate Applications 503 and structures in Data Memory 507 to perform Venue Server 202 function. FIG. 5 is shown configured as a Venue Server 202. Venue Server 202 functions can be packaged in numerous ways, including in a single server, in a plurality of servers, or integrated with Central Server 200 functions.

Venue Server 202 performs the functions required in a Point-of-Service system that are in support of Point-of-Service Terminals 204 in a location. CPU 500 is a conventional microprocessor with a Local Bus 509 that connects it to Disk Drive(s) 505, a Local Area Network Adapter 506, a Wide Area Network Adapter 508, a Program Memory 502 and a Data Memory 507. CPU 500 contains a Clock 501 that provides time in a form that includes the Month, Day-of-week, Hour, Minute, Seconds, and fractions of Seconds.

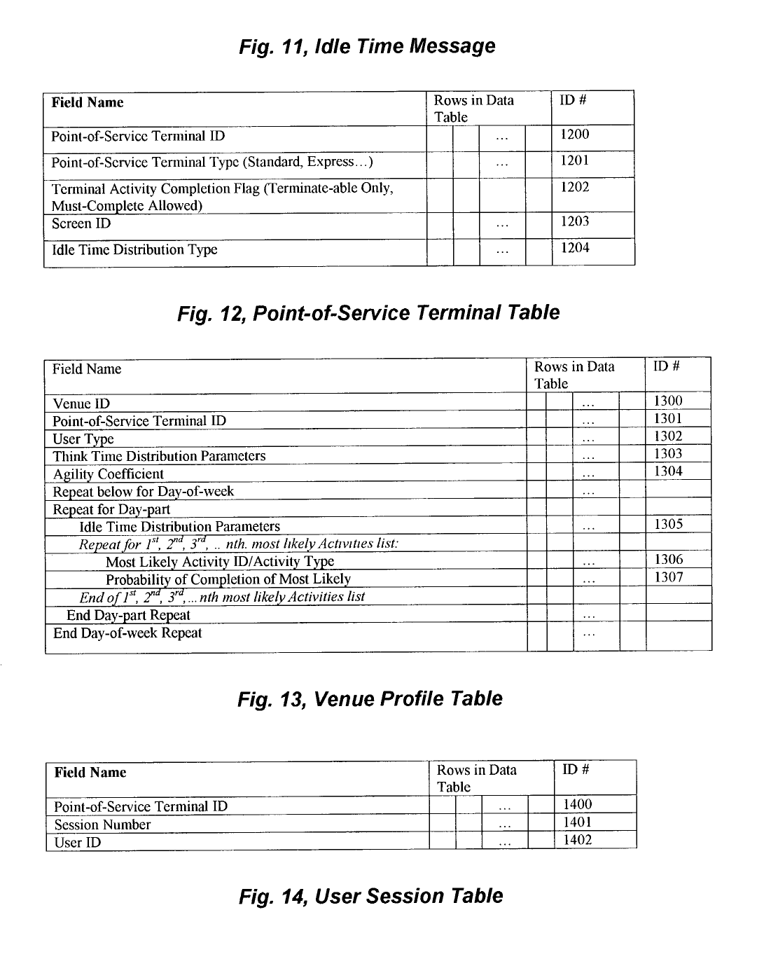

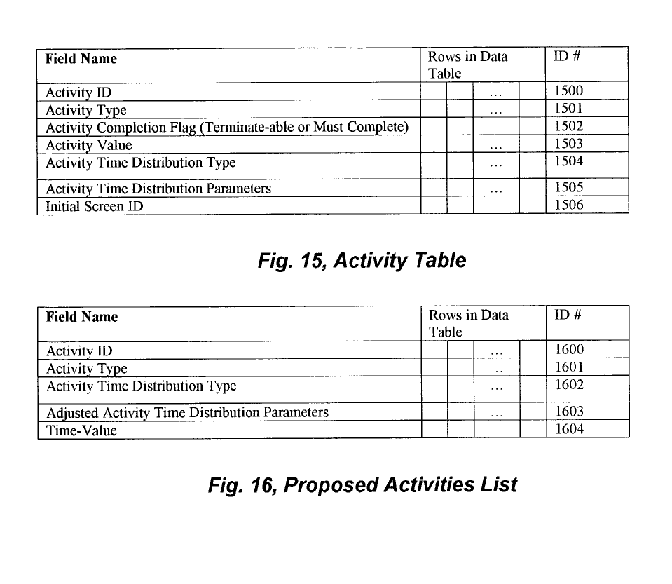

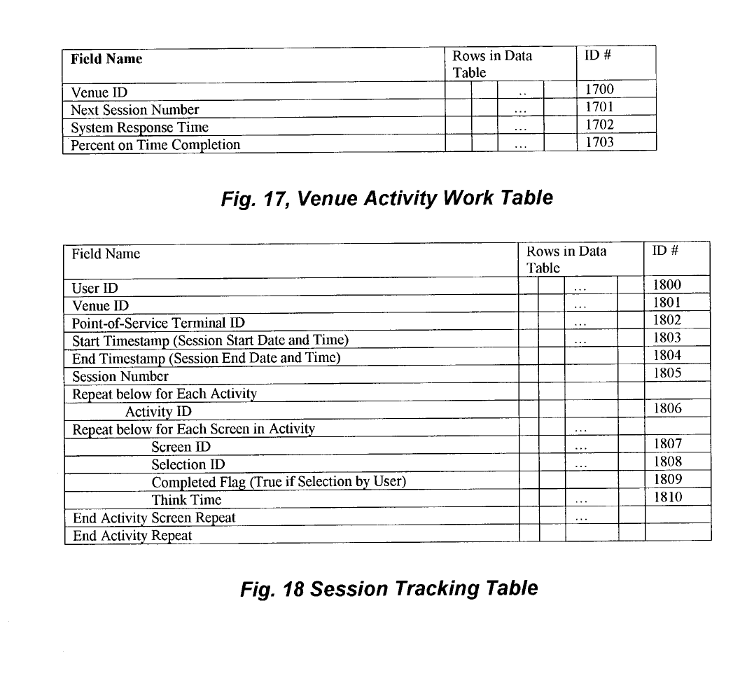

This Data Memory 507 typically contains the following: User Venue Profile Table 510 (See FIG. 10), User Identification Card Table 511 (See FIG. 10), Venue Definition Table 512 (See FIG. 10), Idle Time Message 513 (See FIG. 11), Point-of-Service Terminal Table 514 (See FIG. 12), Venue Profile Table 515 (See FIG. 13), User Session Table 516 (See FIG. 14), Proposed Activity List 518 (See FIG. 16), Activity Table 517 (See FIG. 15), and Venue Activity Work Table 520 (See FIG. 17)

Application 503 acquires information from Central Server 200 via Wide Area Network Adapter 508 and WAN 201 to build data structures in Data Base Software 504, Data Memory 507 and to update Disk Drive(s) 505. It then uses that information to communicate with Point-of-Service Terminal 204 vial Local Area Network Adapter 506 and LAN 203, entering into a dialog with a user presenting Activities 700 to the user and receiving responses. Activities 700 are selected from Activity Table 517 based on the identification or non-identification of the user. This is done using User Identification Card Table 511 to convert the external user identifier into a User ID 900 and subsequently using it to access either User Venue Profile Table 510 (identified user) or Venue Profile Table 515 (non-identified user) respectively. Once the profile is selected, its information is used, in conjunction with Idle Time Fit Criteria 1002 from Venue Definition Table 512, Venue Activity Work Table 520, and System Response Time Table 521 to select user Activities 700 from Activity Table 517. These are then presented to the user using Point-of-Service Terminal 204. The Activities presented to the user during each session, the user selections and think time, are recorded in the Session Results Table 519 to be analyzed and to update the profile tables.

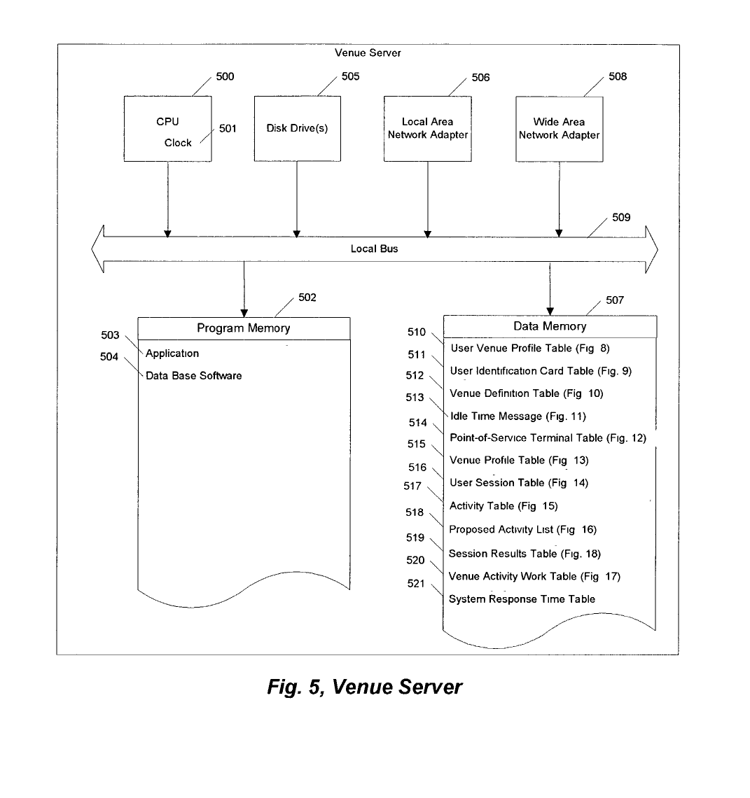

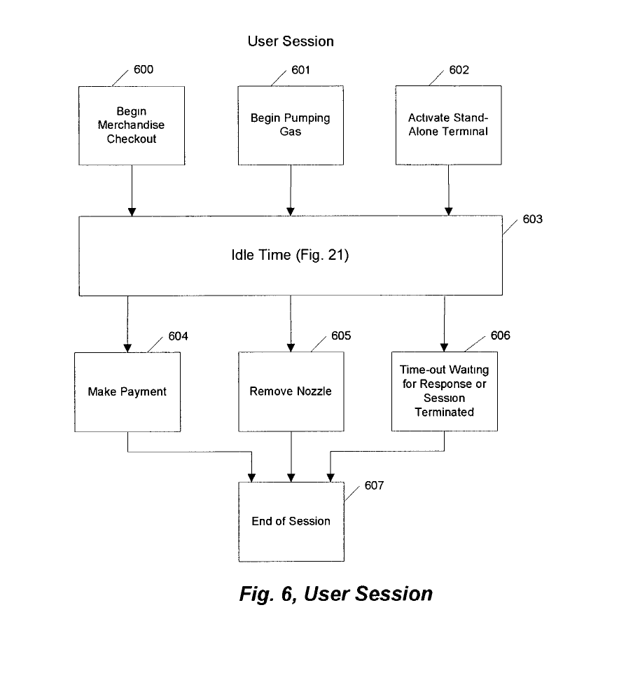

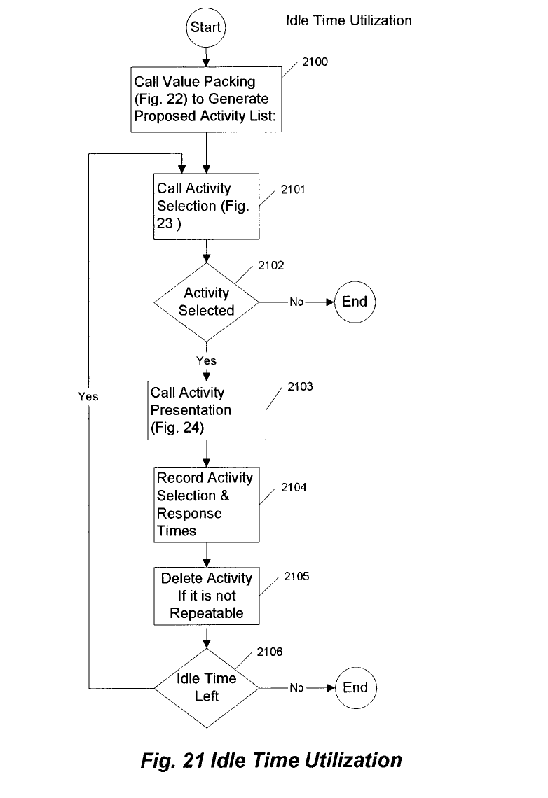

FIG. 6, User Session, is a diagram that describes a typical User Session in a three common Venues; a market or department store, gas station and a stand-alone terminal you might find in kiosk. In a market or department store, the User Session is initiated at Begin Merchandise Checkout 600, in the gas station it is at Begin Pumping Gas 601. The user would Activate Stand-Alone Terminal 602 when they triggered an input device such as a button, touch screen or passing a magnetic card. The End of Session 607 would occur after the user Make Payment 604 in a store or Remove Nozzle 605 at a gas station. The Stand-Alone Terminal session would end after a Time-out Waiting for Response or Session Terminated 606 by the user via an input device. Between these points, is the Idle Time 603. This invention is how to get the most Value out of this Idle Time. It is not so much concerned with the Stand-Alone Terminal, since the Idle Time 603 is not limited there, but Stand-Alone Terminals can benefit from Value Packing the Activities selected to present on those terminals. FIG. 21, Idle Time Utilization, describes how the Activities are selected and presented to the user during Idle Time 603.

FIG. 7 is a diagram of a structure that represents user Activity dialog. Activity 700 is composed of a number of screen presentations with user dialog responses. The set of Screens 701 are defined in FIG. 16, Activity Table. The Activities are selected from the Proposed List of Activities. Each Activity has an Initial Screen ID 1506 which is the first Screen 701 to bring up. This is shown in the diagram starting block as Initial Screen ID 702. Screen 701 contains zero to n possible selections, represented as Selection ID 1 704, Selection ID 2 706 through Selection ID n 708. When the user responds, the Selection ID associated with the user's response is processed, and the Screen associated with that selection is displayed next. The FIG. 7 Activity diagram shows these corresponding screens as Next Screen ID 1 705, Next Screen ID 2 707 . . . . Next Screen ID n 709. The selections are activated by input devices attached to the Point-of-Service Terminal 204 as specified by the various Selection IDs. In this case, when Selection ID 1 704 is executed, the Screen with a Screen ID equal to Next Screen ID 1 705 will be brought up. This Screen has it's own set of possible Selections and associated Screens. Each Screen 701 also has a Default Selection ID 703 which is executed by system to terminate a Dialog for the user when time runs out. The Default Selection ID 703, would only be used by activities with an Activity Completion Flag 1502 marked as “Terminate-able”. An activity, with Activity Completion Flag 1502 marked as “Must-Complete”, will not send a Default Selection ID 703 when the time expires. Activities marked with Activity Completion Flag 1502 as “Terminate-able”, are activities that do not require permission from the user and would not disturb the user too much if they were suddenly terminated. A fast food purchase or complicated survey would probably have an Activity Completion Flag 1502 marked as “Must-Complete”. An offer to print a coupon might have an Activity Completion Flag 1502 marked as “Terminate-able” with the Default Selection ID 703 set to print the coupon and terminate the session. The Screen ID 1203, for that Point-of-Service Terminal ID 1200, is displayed at the End of Session 607. Each Screen 701 is a table with a list of the allowable Selection ID's (in this case: Selection ID 1 704, Selection ID 2 706 . . . Selection ID n 708) and Screen IDs (in this case: Next Screen ID 1 705, Next Screen ID 2 707 . . . Next Screen ID n 709), of the screen that is to be displayed if that selection is made. Only one of the Selection IDs is executed per screen, depending on what the User response is. Each Screen 701, is chained to the next screen based on the user selection. As the Screen ID is used for the linkage, any meshed structure of User Activity Blocks is possible. The response may indicate the users acceptance of an offer, rejection of an offer, the desire to page forward or backward in the dialog, or other meanings consistent with content of the dialog being presented. The details of such dialog management are well understood by anyone skilled in the state of the art. Activity 700 dialogs can be constructed to any length by replicating the structure in Screen 701 and chaining each subsequent layer of the structure to a previous layer.

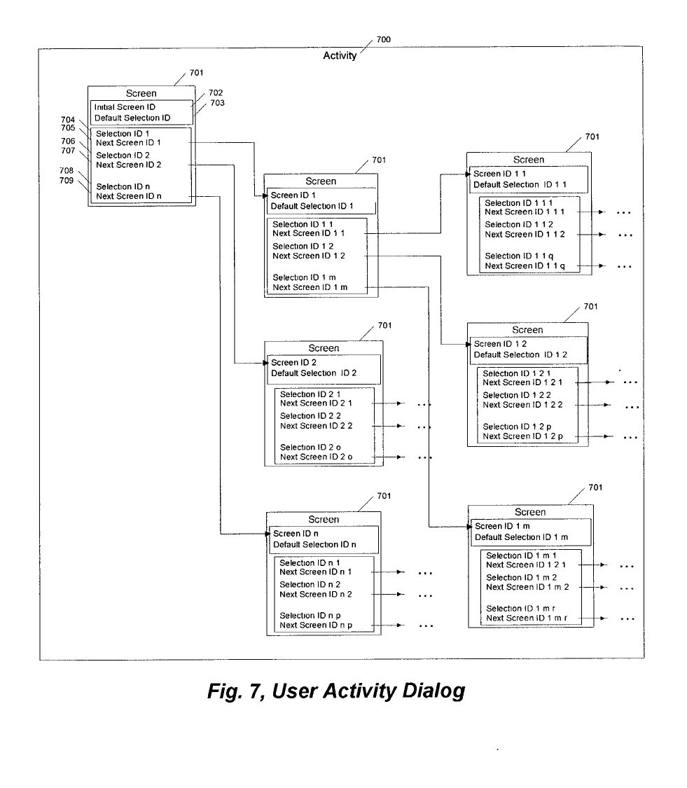

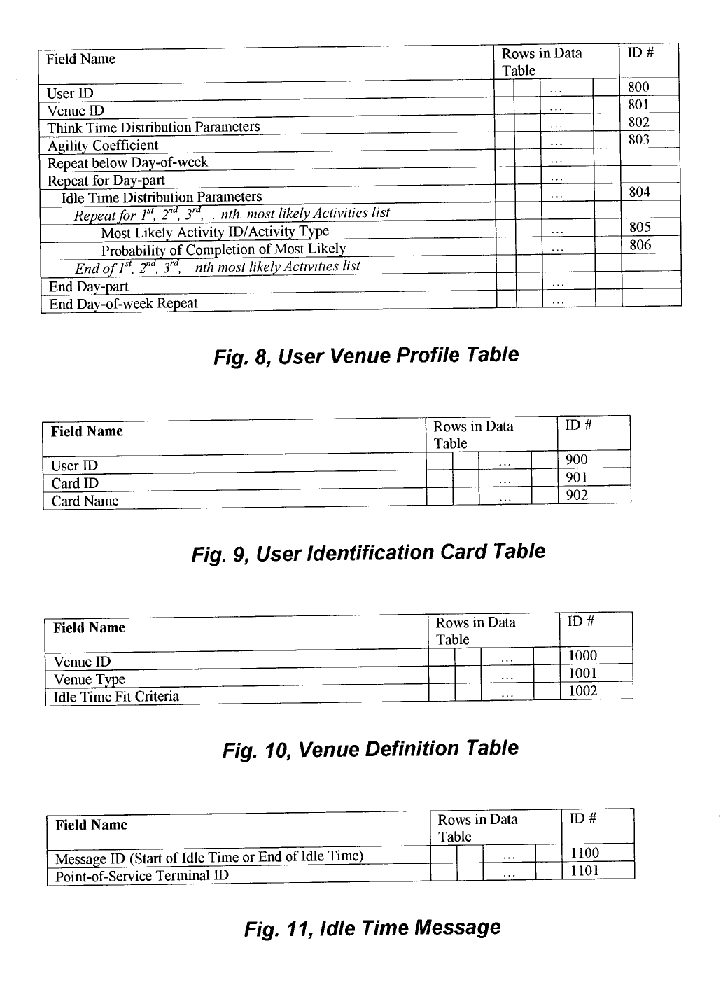

FIG. 8 is the User Venue Profile Table. It contains the information needed by Venue Server 202 to interact with an identified user. Such users have used the same identification a sufficient number of times to merit the Central Server's 200 generation of a User Venue Profile Table. This table is updated with data on user choices and response times collected during User Sessions (see Block 2304 in FIG. 21 Idle Time Utilization.) It is always available with a list of most likely activities the user would respond favorably to at that Venue at that time of day and that day of the week. The Think Time Distribution Parameters 802 and Agility Coefficient 803 are used when estimating time an activity would need to complete. The User Venue Profile Table is transferred by Central Server 200 to the Venue Server 202 via WAN 201 and Wide Area Network Adapter 508 where it is stored in Data Memory 507 and Disk Drive(s) 505. It is composed of the following fields:

User ID 800, which corresponds to User ID 900, is the internal identification used in the system for identified users. Venue ID 801 is a unique identification for each venue participating in the system. Think Time Distribution Parameters 802 are the parameters for the probability distribution that fits the prior experiences with the user. These describe the variability of the user's Think Time 2000. The probability distribution used, is determined by the Idle Time Distribution Type 1204. Agility Coefficient 803 describes the quickness of the user in using the system.

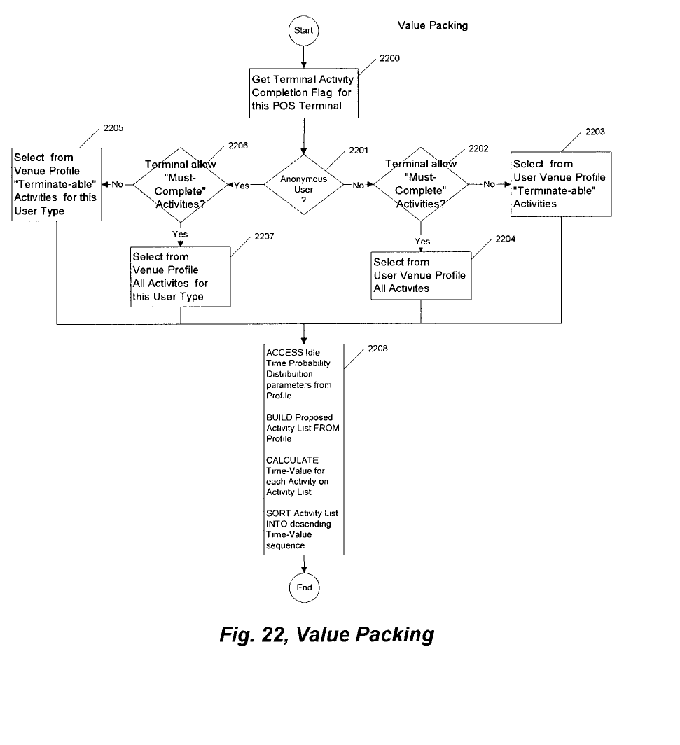

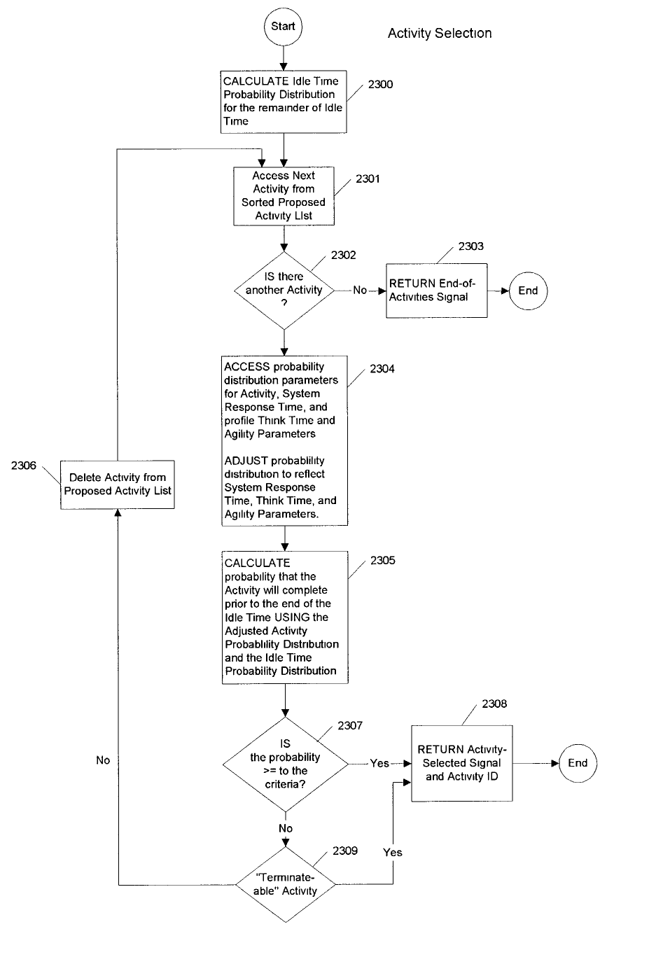

The following fields are repeated for each day-part of each day of the week. Idle Time Distribution Parameters 804 are the parameters for the probability distribution used to describe Idle Time 603. In this embodiment the gamma distribution is used. Its parameters are alpha and beta, which are used in FIG. 22, Value Packing, to calculate the probability that a user Activity 700 will complete prior to the end of the Idle Time 603. Most Likely Activity ID/Activity Type 805 and Probability of Completion of Most Likely 806 Activity ID/Activity Type describe either the Activity ID 1500 or the Activity Type 1501 that has the highest probability to be completed in this period. A list, of any length, of the Most Likely Activity ID/Activity Type 805 to complete in the available period is generated with their corresponding Probability of Completion of Most Likely 806. The list of Activity IDs and/or Activity Types is ordered by the first having the highest most likely probability to be completed, second most likely, third most likely, . . . nth most likely probability to complete. These parameters are used in Block 2208 of FIG. 22, Value Packing, to build Proposed Activity List 518.

An instance of User Venue Profile Table 510 can be used for characterizing groups of users based on similar behaviors. These behaviors include: Think Time Distribution Parameters 802, Agility Coefficient 803, and their Most Likely Activity ID/Activity Types 805. The data from these User Venue Profiles, and the data from other Venues, can be used to build the Venue Profile Table 515 described in FIG. 13.

FIG. 9 is the User Identification Card Table, as seen in FIG. 5, User Identification Card Table 511. The table associates a User ID 900 to Card ID 901 and Card Name 902. User ID 900 is assigned by Venue Server 202 when the user is initially added to the system. Once the user becomes an Identified user, a User Venue Profile will also be stared as described in FIG. 8. Card ID 901 and Card Name 902 are provided to the retailer by the user in the course of the primary transaction being performed. It may be a credit card number, debit card number, a loyalty card number or other ID, or no ID (anonymous ID). User Identification Card Table is used by the system to check if a User ID 900 is an identified or anonymous user.

FIG. 10 is the Venue Definition Table 512. A Venue, which might be a gas station, grocery store, any place that has Point-of-Service Terminals, is uniquely identified by it's Venue ID 1000 key. The table contains the unique Venue ID 1000; Venue Type 1001 which is used, optionally, to build User Venue Profile Tables 510 that span instances of the same Venue Type 1001 or to build Venue Profile Tables that span instances of the same Venue Type 1001, Idle Time Fit Criteria 1002 which specifies the acceptable probability of overrunning the Idle Time 603. Venue Definition Table 512 is built by Central Server 200 as venues are entered into the system.

FIG. 11 is the Idle Time Message. It is referred to as Idle Time Message 513 in FIG. 5. These signals are messages generated by Venue Server 202 when it detects the start or stop of Idle Time 603. Message ID 1100 specifies whether the signal is a ‘Start of Idle Time’ or an ‘End of Idle Time’. Point-of-Service Terminal ID 1101 associates that signal with a specific Terminal. The start and end of Idle Time varies, depending on what type of Terminal is in use. In a grocery store, Idle Time would start when checkout began and end when the total is rung up. At a gas pump, Idle Time would start when the gas started pumping and end when the nozzle is replaced.

When a User Session occurs, the Point-of-Service Terminal ID 1101 and User ID 900 are written to the Point-of-Service Terminal ID 1400 and the User ID 1402 in the FIG. 14, User Session Table. The User Session can then be accessed using the Point-of-Service Terminal ID 1101 sent. The Message ID 1100 ‘End of Idle Time’ is evaluated in Block 2402 of the FIG. 24, Activity Presentation.

FIG. 12 is Point-of-Service Terminal Table, which associates a Screen ID 1203 with a Point-of-Service Terminal ID 1200. That screen is presented at End of Session 607 at Point-of-Service Terminal 204 specified by Point-of-Service Terminal ID 1200. Idle Time Distribution Type 1204 specifies the probability distribution that is to be used for an activity at a specific Point-of-Service Terminal 204. Idle Time Distribution Type 1204 with Idle Time Distribution Parameters 804 (identified user) or Idle Time Distribution Parameters 1305 (anonymous user) constitute the complete definition of the probability distribution for the current instance of Idle Time 603.

Point-of-Service Terminal Type 1201 (Standard, Express . . . ), indicates the type of usage of the terminal. In a grocery store, Point-of-Service Terminal Types 1201 might include: 15 item express lane; 9 item express lane; cash-only express lane; and standard lane. The Terminal Activity Completion Flag 1202 is used during the selection of Activities for this Point-of-Service Terminal ID 1200. It is set to either “Terminate-able Only” or “Must-Complete Allowed”. Activities also have an Activity Completion Flag 1502, which is set to either “Terminate-able” or “Must-Complete”. If the Terminal Activity Completion Flag 1202 is marked as “Must-Complete Allowed”, then the selection of Activities would not be limited to Activity Completion Flag 1502 of “Terminate-able”. A Point-of-Service Terminal Type 1201 that is an “Express Lane” would probably have it's Terminal Activity Completion Flag 1202 set to “Terminate-able Only” since it is important that that lane move a fast as possible.

FIG. 13 is Venue Profile Table 515. It is supplied from Central Server 200 as part of a periodic download process to the Venue Server 202 via WAN 201. Characteristics of a User Type 1302 are gathered from the User Venue Profile Table 510 from similar Venues and are categorized into groups of users based on similar behaviors. These behaviors include: Think Time Distribution Parameters 802, Agility Coefficient 803, and their Most Likely Activity ID/Activity Types 805. The Venue Profile Table is always available with a list of most likely activities that User Type would respond favorably to at that Venue ID 1300 at that time of day and that day of the week. Venue ID 1300 is a unique identifier assigned by Central Server 200 when the venue is added to the system. Point-of-Service Terminal ID 1301 identifies Point-of-Service Terminal 204 in the venue for that specific profile. For example, the Express Checkout Lane in a venue would have a different Venue Profile Table 515 entry than the normal Checkout Lanes. User Type 1302 is an identifier for a group of users having similar characteristics, which merit a unique profile. The user information used to develop the Venue Profile Table 515 are developed from the user experience from the venue profiled or from venues that are similar to said venue. Think Time Distribution Parameter 1303 are the parameters for the probability distribution that fits the prior experiences with the anonymous users. These describe the variability of the users' Think Time 2000. The probability distribution used is determined by the Idle Time Distribution Type 1204. Agility Coefficient 1304 describes the quickness of the average user in using the system.

The following fields are repeated for each day-part of each day of the week. Idle Time Distribution Parameters 1305 are the parameters for the probability distribution used to describe Idle Time 603. In this embodiment the gamma distribution is used. Its parameters are alpha and beta, which are used in FIG. 22, Value Packing to calculate the probability that a user Activity 700 dialog will complete prior to the end of the Idle Time 603. Most Likely Activity ID/Activity Type 1306 and Probability of Completion of Most Likely 1307 Activity ID/Activity Type describe either the Activity ID 1500 or the Activity Type 1501 that has the highest probability to be completed in this period. A list, of any length, of the Most Likely Activity ID/Activity Type 1306 to complete in the available period is generated with their corresponding Probability of Completion of Most Likely 1307. The list of Activity IDs and/or Activity Types is ordered by the first having the highest most likely probability to be completed, second most likely, third most likely, . . . nth most likely probability to complete. These parameters are used in FIG. 22, Block 2208 to build Proposed Activity List 518.

FIG. 14 is the User Session Table, seen in Data Memory 507, of FIG. 5, as User Session Table 516. A FIG. 6, User Session, is recorded in the User Session Table, at the point the user is identified during checkout Idle Time 603. User Session Table contains: Point-of-Service Terminal ID 1400, which identifies the checkout counter, gas pump, or other terminal used by the user; Session Number 1401, is assigned by Venue Server 202 when the user is identified; and User ID 1402, which is provided by the user, generally by passing an identification card Magnetic Stripe Reader 408, or is identified as an anonymous user, if no identification is used. User Venue Profile Table 510 is located by using User ID 1402 to find the entry, and the time from Venue Server's 202 internal Clock 501 is used to locate the User Venue Profile Table 510 Day-of-week and Day-part, which are to be used. In a similar manner, the anonymous user is processed using the Venue Profile Table 515.

FIG. 15 is the Activity Table that has all the activities offered in the venue. Activity Table 517 is stored in Data Memory 507, in FIG. 5. The Activities in the Activity Table represent the starting point of a Screen dialog cycle starting with Initial Screen ID 1506. Each Activity also contains information that is used during selection when deciding if the Activity is right for that Terminal, Venue, User and can be completed in the estimated Idle time. Activities are described in the form of outputs to the user in the form of screen, video, and audio presentations; and inputs in the form of touchscreen, key pad, voice, card readers and other devices at the point of sale. A diagram of how an Activity might be set up is shown in FIG. 7. An Activity 700 is a dialog composed of said inputs and outputs that is presenting ads, information messages, coupon offers, offers to buy, surveys, etc. to the user. It contains: Activity ID 1500 which uniquely identifies the activity; Activity Type 1501, which specifies the general characteristics of the activity and, Activity Value 1503, which specifies the economic value of the activity; Activity Time Distribution Type 1504, which specifies the type of probability distribution used to describe the activity; and Activity Time Distribution Parameters 1505, which complete a normalized description of the time to complete the activity.

The Activity Completion Flag 1502 is set to either “Must-Complete” or “Terminate-able”. A Terminate-able activity is one where the system can send a Default Selection ID 703 for the user when Idle Time 603 has expired. An Activity Completion Flag 1502 of “Must-Complete”, means that the user should be allowed to continue with the activity even though the Idle Time 603 has expired.

If the Activity has an Activity Completion Flag 1502 marked as “Terminate-able”, every Screen that could be called in the Activity, must have a value in the Default Selection ID 703 field. At any point in the activity, idle time could expire and the system would need to know which Default Selection ID 703 it should execute.

The Initial Screen ID 1506, is the first Screen 701 (represented in FIG. 7 diagram as Initial Screen ID 702) to display when the Activity starts. A picture of how an Activity is set up is shown in FIG. 7, Activity.

FIG. 16 is Proposed Activity List, which are the activities from the FIG. 15, Activity Table, that are candidates to be presented to a user. Proposed Activity List Activities are selected from the Activity Table 517 (see FIG. 15), using the User Venue Profile Table 510 or Venue Profile Table 515 indicated by the User ID 1402 (identified or anonymous user). Because of other criteria, other user Activities 700 may be added to this list, such as an advertiser contracting to have an ad presented to every user.

If the Terminal Activity Completion Flag 1202 is “Terminate-able Only”, then Activities with an Activity Completion Flag 1502 that are “Terminate-able” are selected, otherwise, it is not tested. The Activity Completion Flag 1502 is checked by the system during the Activity, when Idle time expires, to determine if it can terminate the Activity for the user or if it must wait for the user to complete it.

Activity Time Distribution Parameters 1505 is adjusted as in FIG. 22 and placed in Adjusted Activity Time Distribution Parameters 1603. Time-Value 1604 is calculated by finding the mean of the distribution specified by Adjusted Activity Time Distribution Parameters 1603 and dividing it into Activity Value 1503.

Activity Type 1601, specifies the general characteristics of the activity, and is used to categorize Activities. This data can be used when calculating probabilities of the user selecting new Activities of the same type that they have historically responded favorably to.

Proposed Activity List entries; Activity ID 1600, Activity Type 1601, and Activity Time Distribution Type 1602 are copied from FIG. 16, Activity Table, entries; Activity ID 1500, Activity Type 1501, and Activity Time Distribution Type 1504.

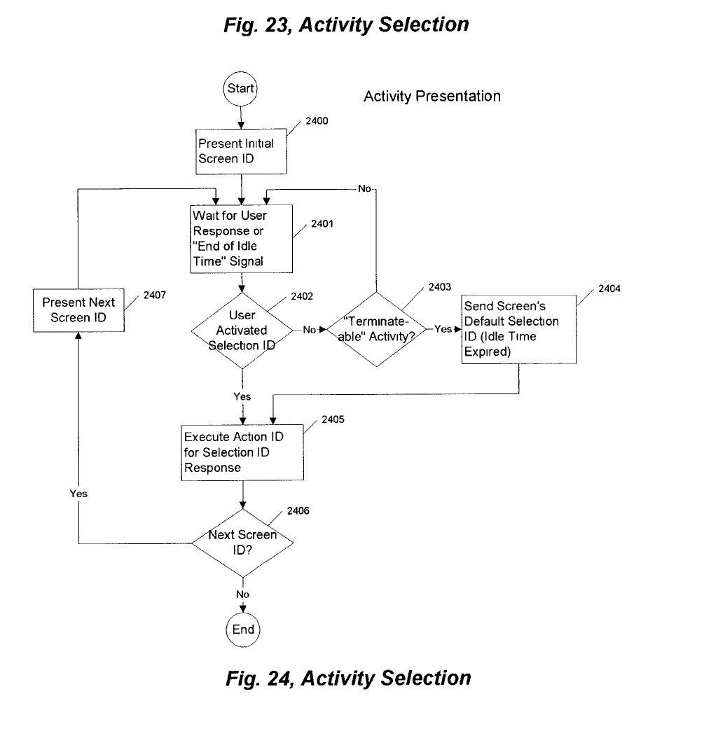

Proposed Activity List is built in Block 2100 of FIG. 21, and used in FIG. 23 as part of the activity selection process. In the process of building the list, Adjusted Activity Time Distribution Parameters 1603 are adjusted using System Response Time 1702 and either Think Time Distribution Parameters 802 or Think Time Distribution Parameters 1303, depending on whether the user has be identified or is anonymous.

Tracking

FIG. 17 is the Venue Activity Work Table. It is shown in Data Memory 507 of FIG. 5, Venue Server, as Venue Activity Work Table 520. Venue Activity Work Table is composed of Venue ID 1700 and Next Session Number 1701. Next Session Number 1701 is initialized with the value of zero. It is incremented by one each time a Session Number 1401, in the FIG. 14, User Session Table, is assigned. When the field overflows, it is reset to zero. The field size is picked such that the Next Session Numbers 1701 assigned in one 24 Hour period, are unique. System Response Time 1702 is calculated dynamically from the current system load. Percent on Time Completion 1703 is the overrun criteria for the venue. The Venue Activity Work Table is built by Venue Server 202 at system bring up. This table is in Venue Server 202 and has one entry for the venue.

FIG. 18 is the Session Tracking Table. Raw data gathered during a user session is recorded in this table to calculate current System Response Time and to upload into the Central Server 200 for further processing. A user (identified by User ID 1800) is presented with one or more Activities (Activity ID 1806) during a session. Each Activity ID 1806 has one or more possible screens (Screen ID 1807) that might be presented, depending on user selection (Selection ID 1808). The Completed Flag 1809 is set to True if the user made the selection and False if the system executed a Default Selection ID 1901 for the screen offers. This information is important, because it is not known if that would have been the user's choice. A Timestamp (Start Timestamp 1803) is taken when the session starts. Information about the time of year, day of the week and time of the day is derived from the Start Timestamp 1803 and is used in conjunction with the user choices (Selection ID 1808) and are used when setting up Most Likely Activity ID/Activity Type 805 in the User Venue Profile Table.

The Think Time 1810 is the length of time from screen presentation to user response with a Selection ID 1808. Start Timestamp 1803 is the beginning of the session, End Timestamp 1804 is the end of the session. During this time period, the Proposed List of Activities was collected from the User Venue Profile Table, parsed for Idle Time available, System response time and the first Activity presented. The Think Time 1810 and System Response Time are used in calculating the Think Time Distribution Parameters 802 and Agility Coefficient 803 for the User ID 1800 in that Venue ID 1801.

The Point-of-Service Terminal ID 1802 and Session Number 1805 are needed as an identifier for which session the data is being collected for that Venue. The Point-of-Service Terminal ID 1802 and Venue ID 1801 can also be used when categorizing a User Type 1302 for the Venue Profile Table which contains the Most Likely Activity ID/Activity Types 1306 for anonymous users at that Venue ID 1300 and Point-of-Service Terminal ID 1301.

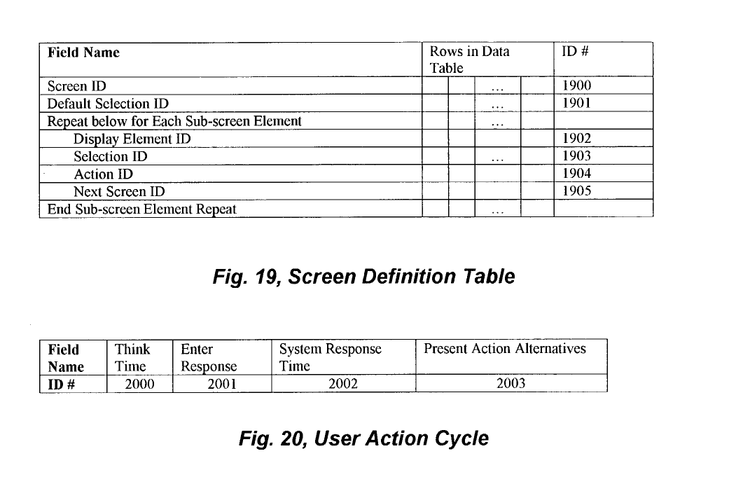

FIG. 19 is a Screen Definition Table, which is a general description of a Screen. It is composed of: a Screen ID 1900, which is a unique identifier assigned by Central Server 200 during the screen definition process. There are one to many sub-screen elements, which are the user interface elements that communicate offers, options and information to the user. These might be graphics or text displayed on the screen or an audio recording. They are represented, in the Screen Definition Table, as Display Element ID 1902. If the Display Element ID 1902 is something that the user can respond to, it will also have a Action ID 1904, Input Element ID, and maybe, a Next Screen ID 1905 (if it is not the end of the Activity cycle.) associated with it. Selection ID 1903 is the input device tied to that Display Element ID 1902. An input device might be a Touch Screen or Keypad button or Audio microphone. It represents the response from the user to the associated Display Element ID 1902. When Input Element ID is activated, Action ID 1904 is executed. The Selection ID is what the system should do in response to the user response, it might be to print a coupon or add an element to the purchase list, send the purchase request or go back to the previous screen. The Display Element ID 1902 can also be information that is presented to the user without an Selection ID 1903 and Action ID 1904, for user response, tied to it. Some selections, in the Activity might require that another Screen be displayed. In this case, there will be a value in Next Screen ID 1905.

The user will Enter Response 2001 by selecting the Selection ID 1903 which activates the Action ID 1904, which will Present Action Alternatives 2003, which may require a Next Screen ID 1905 to display. If so, then Next Screen ID 1905 will have a value that points to another Screen ID 1900. The Next Screen ID 1905 is how the screens are chained together to create the User Action Dialog Cycle described in FIG. 20, User Action Cycle, FIG. 24 Activity Presentation, and FIG. 7, Activity.

The Activity ID 1600 has an Initial Screen ID 1506 which is the key to display Screen ID 1900 to start an Activity 700. The Default Selection ID 1901 is what the system will execute, for the user, if Idle Time expires. When the Screen is designed, if it is the type of screen that could be Terminated by the system without dissatisfaction to the user, then the designer will pick the Default Selection ID 1901 that would be best. The Default Selection ID 1901 would be one of the Action IDs 1904 tied to an Selection ID 1903 on the Screen. Just because the Screen has a Default Selection ID 1901, it does not mean that it can be used by the system. Activities are set up for different Venue IDs 1300 and Point-of-Service Terminal ID 1301 (based on Point-of-Service Terminal Types 1201) and different User Types 1302 (based on Agility Coefficient 1304 and Think Time Distribution Parameters 1303) and the available Idle Time 603 (which is also affected by System Response Time 2002) and Activity Time Distribution Type 1602, many Activities 700, can use the same Screen. If the Activity Completion Flag 1502 is marked as “Terminate-able”, then the system will execute Default Selection ID 1901, when the Message ID 1100 ‘End of Idle Time’ is received. Some may allow the system to send the Default Selection ID 1901 (with Activity Completion Flag 1502 marked as “Terminate-able”) and others may not (with Activity Completion Flag 1502 marked as “Must-Complete”.)

The Default Selection ID 1901 must match up with one of the Selection IDs 1903 available for user response. The Display Element ID 1902 that is associated with the Selection ID 1903, that matches up to the Default Selection ID 1901, would be the last action in Activity and would never be tied to a Display Element ID 1902 that required a Next Screen ID 1905. The reason for this is, that the point of the Default Selection ID 1901 is, for the system to end the Activity cycle gracefully for the user FIG. 20 is a diagram that describes User Action Cycle. The Action Cycle is viewed from the user's perspective and is tied to each Screen 701 displayed on the Display Screen 407. The user reads and thinks about the information presented during Think Time 2000. Once a decision is made, the user responds during Enter Response 2001. The system evaluates the response, which is in the form of a Selection ID, and then at the end of System Response Time 2002, Present Action Alternatives 2003 in the form of next Screen 701 to the user. The user makes a choice by selecting a Action ID 1904 associated with the Next Screen ID 1905 in the user Activity 700 dialog. This cycle repeats for each Action described in Block 2401 of FIG. 24, Activity Presentation.

If the Activity Completion Flag 1502 is Terminate-able, and the user does not Enter Response 2001 in the available Idle Time 603, then the system will send a Default Selection ID 1901 which will be an Action that causes the Activity to terminate. If the Think Time 2000 exceeds the available Idle Time 603 and the Activity Completion Flag 1502 is marked “Must-Complete”, then the system will continue to wait for the user to Enter Response 2001.

FIG. 21 is Idle Time Utilization, which is flow diagram showing how the Idle Time is used. It is a representation of what occurs during Idle Time 603 during a FIG. 6, User Session. Idle Time 603, is the time between Begin Merchandise Checkout 600 or Begin Pumping Gas 601 and Make Payment 604 or Remove Nozzle 605 when the user has time to interface with the system. Idle Time 603 starts with a Message ID 1100 of ‘Start of Idle Time’ in the FIG. 11, Idle Time Message, and ends with the Message ID 1100 ‘End of Idle Time’ in the related FIG. 11, Idle Time Message.

The system presents a series of Activities 700 which are selected based on the time available, the time required to present the activity and the value of the activity. After the first Activity, completes, if sufficient Idle Time 603 remains, the next Activity is presented. This cycle repeats until the Idle Time 603 remaining is insufficient to present another Activity 700. An Activity 700 is described in FIG. 7. The selection of the Activities 700 is described in FIG. 23 and FIG. 22.

Block 2100 builds the Proposed Activity List of Value Packed Activities. This process is described in FIG. 22.

Block 2101 calls Activity Selection, using Proposed Activity List 518 as a parameter of the call. FIG. 23, describes the Activity Selection process. Upon return from an Activity Selection, control passes to Block 2102.

Block 2102 evaluates the signal returned from FIG. 23, Activity Selection, for an Activity ID or the “End of Activities” signal. If an Activity was found, control passes to Block 2103, otherwise, the process is ended.

Block 2103 presents the Activity returned from FIG. 23, Activity Selection and the User dialog takes place. This is described in FIG. 24, Activity Presentation.

In Block 2104, the system writes statistics regarding the User Response Times and Activity Selections during the Activity session to Session Results Table 519, which are used by the Central Server 200 to update the Most Likely Activities in the User Venue Profile Table and Venue Profile Table as well as the various activity Agility Coefficients and Time Distribution Parameters.

In Block 2105, if the selected Activity 700 cannot be repeated, it is deleted from the Proposed Activity List 518. Control then passes to Block 2106.

Block 2106, checks to see if Idle Time 603 has ended. If so, the processing of the user ends, otherwise control passes to Block 2101, where the next Activity to present is selected and tested. This cycle will continue until Idle Time expires, or no more Activities are in the Proposed Activity List, or none of the Activities left in the list can be completed in the estimated remaining Idle Time.

FIG. 22 is a flow chart describing Value Packing. Value Packing is the building of the Proposed Activity List which is the selection of Activities that have the most value and are most likely to be reacted positively to. Value Packing is called from Block 2100 of FIG. 21, Idle Time Utilization. It starts with Block 2200 where the Terminal Activity Completion Flag 1202 is retrieved from the FIG. 12, Point-of-Service Terminal Table, using the Point-of-Service Terminal ID 1200 in use. The Terminal Activity Completion Flag 1202 will be used to match up to the activities' Activity Completion Flag 1502 in Block 2203 and Block 2205 depending on if the User is anonymous or identified.

Block 2201 is a decision if the User is anonymous or identified. If the User is identified, then data is selected from the User Venue Profile Table 510, using the User ID 800 and Venue ID 801. If, in Block 2202, the Terminal Activity Completion Flag 1202, is “Must-Complete Allowed”, then Block 2203 will select all of the Activities in the User Venue Profile Table as candidates for the Proposed Activity List. If, in Block 2202, the Terminal Activity Completion Flag is “Terminate-able Only”, then, in Block 2204, Activities with their Activity Completion Flag 1502 marked as “Terminate-able” are selected from the User Venue Profile Table.

If the User is anonymous in Block 2201, then the data is selected from the Venue Profile Table 515 using the User Type 1302. If, in Block 2206, the Terminal Activity Completion Flag 1202, is “Must-Complete Allowed”, then Block 2207 will select all of the Activities in the Venue Profile Table as candidates for the Proposed Activity List. If, in Block 2206, the Terminal Activity Completion Flag 1202 is “Terminate-able Only”, then in Block 2205, Activities with their Activity Completion Flag 1502 marked as “Terminate-able” are selected from the Venue Profile Table.

Once the Activities are selected based on the user (or type of user) and what type of Terminal they are using, the set of selected Activities are processed in Block 2208.

Block 2208 accesses the Idle Time Distribution Parameters 804 (identified user) or Idle Time Distribution Parameters 1305 (anonymous user). It then builds the Proposed Activity List 518 from the activity information User Venue Profile Table 510 (identified user) or Venue Profile Table 515 (anonymous user), and the Activity Table 517 (see FIG. 14). based on other criteria, additional user Activities 700 can be added to the list. Time-Value 1604 is calculated as specified in FIG. 14. The Time-Value 1604 can be calculated by dividing the Activity Value 1503 by the mean of the adjusted activity time probability distribution, which, optionally, can be multiplied by the Probability of Completion of Most Likely 806 Activity ID/Type, for an identified user, and Probability of Completion of Most Likely 1307 Activity ID/Type, for an anonymous user. The Proposed Activity List 518 is then sorted into descending sequence on Time-Value 1604. The Value Packed Activities are then selected from the Proposed Activity List in FIG. 23, Activity Selection.

FIG. 23 is a flow chart for Activity Selection, which is the process of going through the Proposed Activity List and evaluating each Activity against it's probability of completion given the current user and system response time. Activity Selection is called from Block 2101 in FIG. 21, Idle Time Utilization, after the Proposed Activity List is built. Activity Selection goes through the Proposed Activity List, starting at the top, until it finds one who's probability of completion fits in the estimated Idle Time, and returns the Activity for processing.

Activity Selection starts at Block 2300. Block 2300 calculates the Idle Time Probability Distribution for the remainder of the Idle Time 603 using standard statistical formulas, by accessing the Idle Time Distribution Parameters 804 (identified user) from the User Venue Profile Table, or Idle Time Distribution Parameters 1305 (anonymous user) from the Venue Profile Table, and the Idle Time Distribution Type 1204 from Point-of-Service Terminal Table 514.

Block 2301 attempts to access the top of the sorted Proposed Activity List for the most value packed Activity 700. Block 2302 tests if there were any Activities left in the list. If not, then control moves to Block 2303. Block 2303 sends an “End of Activities” signal indicating that no activity met the criteria and returns to the process that called Activity Selection. If there was an Activity, it's probability of completion in Idle time is tested in Block 2304.

Block 2304 accesses Activity Time Distribution Type 1602, and Adjusted Activity Time Distribution Parameters 1603 from Proposed Activity List 518. Then it access System Response Time 1702 from Venue Activity Work Table 520 and either Think Time Distribution Parameters 802 (identified user) or Think Time Distribution Parameters 1303 (anonymous user). These are used to produce an adjusted activity time distribution for the user Activity 700. Then it passes control to Block 2305.

Block 2305 uses the scaled idle time distribution from Block 2300 and the adjusted activity time distribution from Block 2304 and calculates the probability that the Activity 700 will complete prior to the end of Idle Time 603. This can be done by using integral calculus. Then it passes control to Block 2306.

Block 2306 sets up to access the next Activity 700 in the Proposed Activity List 518 by deleting the top Activity 700 in the Proposed Activity List 518 and then.

Block 2307 compares the probability produced in Block 2305 with the Idle Time Fit Criteria 1002. If it is greater than or equal to the criteria, control passes to Block 2308, otherwise, control passes to Block 2309 where the Activity Completion Flag 1502 is tested. If the Activity is “Terminate-able” in Block 2309, then Control passes to Block 2308, if not, then control passes to Block 2306 where the Activity is deleted from the Proposed Activity List. Control then loops back up to Block 2301 where the next Proposed Activity in the list is evaluated.

Block 2308 sets up the return signal and indicates the selected Activity ID. It then returns to the process that called Activity Selection.

FIG. 24 is Activity Presentation, which is what occurs during a single Activity. An Activity is a cycle of Screens displayed with offer(s) and the user dialog responses to those offers. Some Activities might have only one Screen that can be displayed, other Activities can have a combination of Screens, based on user response, that make up the Activity. Activity Presentation is called from Block 2103 of FIG. 21, Idle Time Utilization.

Block 2400 presents the first Screen 701 in the Activity, which is Initial Screen ID 702 (Initial Screen ID 1506.) In Block 2401 the system waits for either a response from the user to the Display Element IDs 1902 on the Screen or when the Message ID 1100 ‘End of Idle Time’ is sent.

Block 2402 tests if the response is an Idle Time expired message or a user response. If it was a Message ID 1100 ‘End of Idle Time’, Block 2403 is executed. Block 2403 tests Activity Completion Flag 1502 to determine if it is “Terminate-able”. If the Activity is “Must-Complete”, control returns to Block 2401, waiting for a user response to a Selection ID 1903. If the Activity is marked as “Terminate-able”, the system will execute, in Block 2404, the screen's Default Selection ID 1901 for the User. The Default Selection ID 1901 is the same as one of the Selection IDs 1903 on the Screen that can activated by the user by pressing a button or touch screen or some other input device.

If the test in Block 2402 finds that the Selection ID 1903 was activated by a User via an input device, the associated Action ID 1904 is executed. Action ID 1904 might be to print a coupon or add an item to a purchase list or to go back to the previous screen. The system takes the action when Selection ID 1903 is activated.

Block 2405 performs all the action specified by Action IDs 1904 in the curent FIG. 19, Screen Definiton Table.

Block 2406 tests if there is a value in the Next Screen ID 1905 field associated with the Selection ID. If there is a value, then, in Block 2407, that Screen ID 1900 will be displayed and the cycle of waiting for a response to the offers on the new Screen 701 in Block 2401 will start over.

If, in Block 2406, there was not a value in Next Screen ID 1905 (which would always be the case for a Default Selection ID 1901), control returns to Block 2105 of FIG. 21.

1. A system for presenting one or more activities to a user in a more efficient manner based on the history of prior use, the system is comprised of:
one or more terminals at one or more venues, said terminals having means for presenting information to said user and recording responses from said user;
a server with which said terminals can communicate, said server having an activity database, means to store criteria for terminating said activities, means to detect the start and end of said users primary transaction, and means to estimate the probable length of said primary transaction:
said activity data base containing must-complete activities and terminate-able activities, and means to estimate the time to complete said activities;
said criteria being based on whether said activity is a said must-complete activity or said terminate-able activity;
means for selection of one of said activities for presentation to said user, said selection means using: means to chose from said must-complete activities and said terminate-able activities based on an estimate of meeting said criteria; where said estimate is based on said means to estimate the time to complete said activities, and said means to estimate the remaining time of said primary transaction;
means to present said selected activity to said user via said terminals
means to terminate said terminate-able activities at the end of said users said primary transaction, and means to complete said must-complete activities after the end of said users said primary transaction.

2. A system as in claim 1, where further means are provided for an identified user profile means, and an improved said selection means which uses said user profile means to improve the results of said selection means.

3. A system as in claim 1, where further means are provided for using information from one or more second venues to improve the said means to estimate the remaining time of said primary transaction in the first said venue.

4. A system as in claim 1, where further means are provided for using information from one or more second venues to improve the said means to estimate the time to complete said activities in the first said venue.
